(19) United States
(12) Patent Application Publication
(10) Pub. No.: US 2015/0261652 A1
(43) Pub. Date: Sep. 17, 2015

(54) FILTERED BRANCH ANALYSIS

(71) Applicant: International Business Machines Corporation, Armonk, NY (US)

(72) Inventors: Jeremy P. Blackman, Mullaloo (AU); Bret W. Dixon, South Perth (AU); Adrian N. Simcock, Perth (AU)

(73) Assignee: International Business Machines Corporation, Armonk, NY (US)

(21) Appl. No.: 14/208,459

(22) Filed: Mar. 13, 2014

(51) Int. Cl. G06F 11/36

(52) U.S. Cl. CPC G06F 11/3612

(57) ABSTRACT

In a method for providing information to resolve an abnormal termination of software, a processor receives a notification of an abnormal termination of software at a source line within a source code. A processor determines at least one variable from the source line. A processor causes information about the at least one variable to be displayed, wherein information about a variable comprises a variable declaration source line and a value of the variable. A processor receives a first selection of at least one variable from the source line. A processor causes a first branch analysis to be displayed, wherein the first branch analysis comprises a truncated version of the source code based on the received first selection.

### FIELD OF THE INVENTION

The present invention relates generally to the field of program troubleshooting, and more particularly to analysis tools that provide a filtered branch analysis of an abnormal end in a program.

### BACKGROUND OF THE INVENTION

An abnormal end, or abend, is an abnormal termination of software, or a program crash. An abend typically occurs when an application performs an operation which is not allowed by the operating system, software application, or hardware. Typical errors that result in abends are attempts to read or write memory that is not allocated for reading or writing by that application, attempts to execute privileged or invalid instructions, attempts to perform input/output (I/O) operations on hardware devices to which the application does not have permission to access, passing invalid arguments to system calls, attempts to access other system resources to which the application does not have permission to access, or attempts to execute machine instructions with bad arguments (e.g., divide by zero, etc.).

Branch analysis is a test procedure which seeks to determine which sections of a program's code are executed during a run. A computer program consists of a sequence of computer instructions. Generally, the computer executes a program's instructions in the sequential order in which the instructions appear in the program. A branch occurs when an instruction requires jumping, that is, branching, to an instruction other than the next succeeding instruction. A program may branch to a subroutine, or to the top of a nested loop, or to the conditional part of an IF-THEN-ELSE statement, and so forth.

### SUMMARY

Aspects of an embodiment of the present invention disclose a method, computer program product, and computing system for providing information to resolve an abnormal termination of software. A processor receives a notification of an abnormal termination of software at a source line within a source code. A processor determines at least one variable from the source line. A processor causes information about the at least one variable to be displayed, wherein information about a variable comprises a variable declaration source line and a value of the variable. A processor receives a first selection of at least one variable from the source line. A processor causes a first branch analysis to be displayed, wherein the first branch analysis comprises a truncated version of the source code based on the received first selection.

### BRIEF DESCRIPTION OF THE SEVERAL VIEWS OF THE DRAWINGS

FIG. 1 depicts a diagram of a computing system, in accordance with one embodiment of the present invention.

FIG. 2 depicts a flowchart of the steps of an abend analysis tool executing within the computing system of FIG. 1, for providing a filtered branch analysis of an abend in a program, in accordance with one embodiment of the present invention.

FIG. 3A depicts a sample code for analysis by an abend analysis tool, in accordance with one embodiment of the present invention.

FIG. 3B is an example user interface window to an abend analysis tool, in accordance with one embodiment of the present invention.

FIG. 3C is an example user interface window to an abend analysis tool, in accordance with one embodiment of the present invention.

FIG. 3D is an example user interface window to an abend analysis tool, in accordance with one embodiment of the present invention.

FIG. 3E is an example user interface window to an abend analysis tool, in accordance with one embodiment of the present invention.

FIG. 4 depicts a block diagram of components of the server executing an abend analysis tool, in accordance with one embodiment of the present invention.

### DETAILED DESCRIPTION

Embodiments of the present invention recognize that, in the case of a program abend, simply presenting the programmer with the failing source statement and the values of variables at the abending line is often insufficient for a thorough determination of the problem. Embodiments of the present invention recognize that a user may find it equally important to know where functions were called, and from where any data used in a function was set. Embodiments of the present invention recognize that a tool is required that can diagnose how an abending source line was reached and how the data/variable usage and reference influenced the abend.

The present invention will now be described in detail with reference to the Figures.

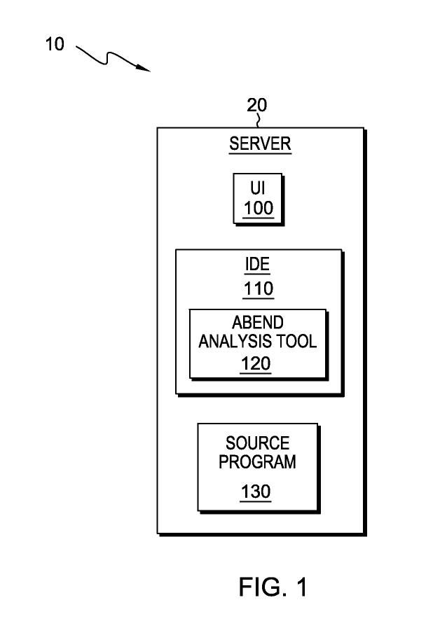

FIG. 1 depicts a diagram of computing system 10, in accordance with one embodiment of the present invention. FIG. 1 provides only an illustration of one embodiment and does not imply any limitations with regard to the environments in which different embodiments may be implemented.

In the depicted embodiment, computing system 10 includes server 20. Computing system 10 may also include a network, servers, computing devices, or other devices not shown.

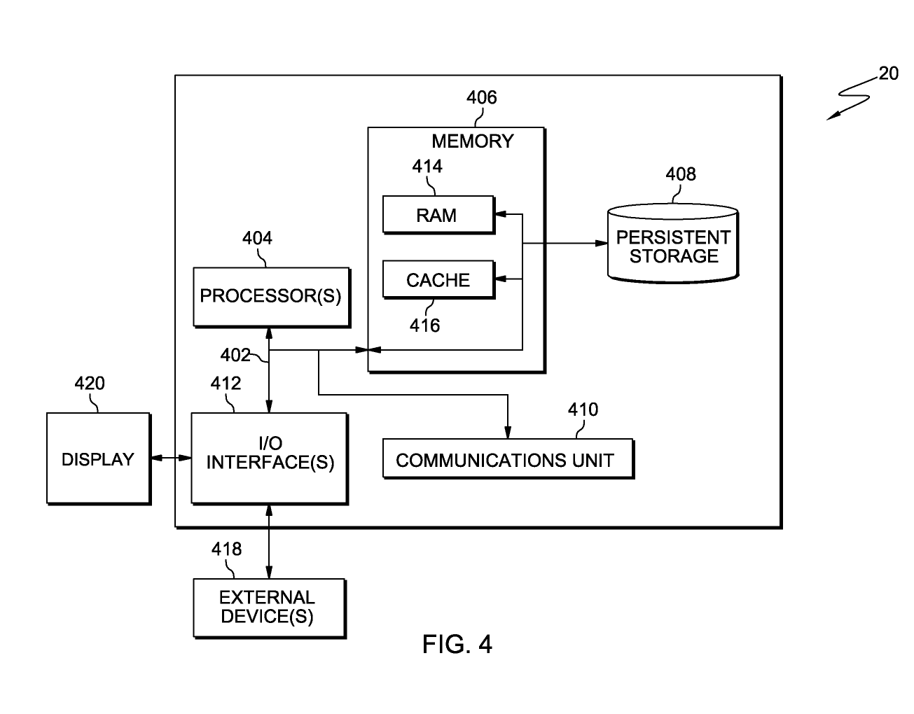

Server 20 may be a management server, a web server, or any other electronic device or computing system capable of processing program instructions and receiving and sending data. In some embodiments, server 20 may be a laptop computer, tablet computer, netbook computer, personal computer (PC), a desktop computer, a personal digital assistant (PDA), a smart phone, or any programmable electronic device. In other embodiments, server 20 may represent a server computing system utilizing multiple computers as a server system, such as in a cloud computing environment. Server 20 contains user interface (UI) 100, integrated development environment (IDE) 110, abend analysis tool 120, and source program 130. Server 20 may include components, as depicted and described in further detail with respect to FIG. 4.

UI 100 operates on server 20 to generate display signals corresponding to content, such as windows, menus, and icons, and to receive various forms of user input. In one embodiment, UI 100 comprises an interface to abend analysis tool 120 and IDE 110. UI 100 may display data received from abend analysis tool 120 and IDE 110. UI 100 may send input to abend analysis tool 120 and IDE 110. UI 100 may comprise one or more interfaces, such as an operating system interface and/or application interfaces.

IDE 110 is a software application that provides comprehensive facilities to computer programmers for software development. IDE 110 may contain a source code editor, build automation tools, and debuggers. In some embodiments, IDE 110 contains a compiler and/or interpreter. In some embodiments, IDE 110 contains a class browser, an object browser, and a class hierarchy diagram, for use in object-oriented software development. In one embodiment, IDE 110 includes abend analysis tool 120. In one embodiment, IDE 110 resides on server 20. In another embodiment, IDE 110 may reside on another server or another computing device, provided that IDE 110 has access to source program 130, and provided that IDE is accessible to a user through UI 100.

Abend analysis tool 120 operates to provide a filtered branch analysis for a program, such as source program 130, after an abend or program crash. Based on received abend and compiler information, abend analysis tool 120 generates and displays a branch analysis of the abend, while filtering out extraneous lines of the source code of the abending program, such as source program 130. For example, abend analysis tool 120 may display the abending source line, variables used on the abending source line. Compiler information may include diagnostic and cross reference information associated with a program, such as source program 130, and or other information associated with compilation of the program. Abend analysis tool 120 may allow a user to select particular variables in the source code and display the usage of the variable throughout the source code. In some embodiments, abend analysis tool 120 is a function of IDE 110. In other embodiments, abend analysis tool 120 is a stand-alone program capable of receiving compiler and abend information and analyzing the information to produce a branch analysis, as described.

Source program 130 is a generic program that includes source code for analysis by IDE 110 and/or abend analysis tool 120. Embodiments of source program 130 source code may be written in COBOL, C++, Smalltalk, or other programming languages. In embodiments of the present invention, source program 130 contains a programming error that produces an abend upon execution. In some embodiments, source program 130 resides on server 20. In other embodiments, source program 130 may reside on another server or another computing device, provided that source program 130 is accessible to IDE 110 and/or abend analysis tool 120.

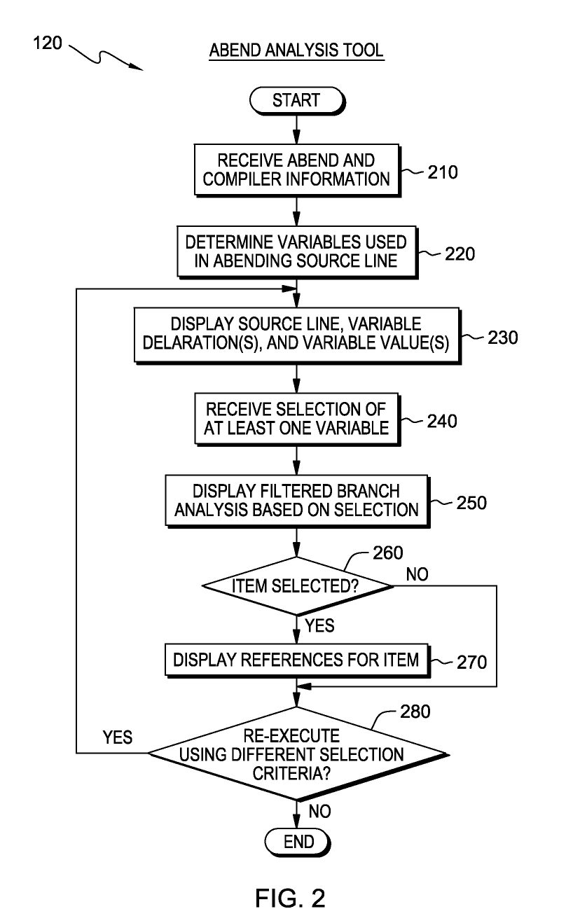

FIG. 2 depicts a flowchart of the steps of abend analysis tool 120, a function of IDE 110, executing within the computing system of FIG. 1, in accordance with an embodiment of the present invention. Abend analysis tool 120 operates to receive abend and compiler information respective to a program that has experienced a problem, such as source program 130, in order to generate and display a filtered branch analysis, for the purpose of interactive problem resolution, in accordance with one embodiment of the present invention.

In one embodiment, initially, a developer may write source code for source program 130. In some embodiments, a developer may write source code for source program 130 using IDE 110. During execution or compilation of source program 130, an error in the source code causes an abend to occur, resulting in a program crash.

In step 210, abend analysis tool 120 receives a notification of an abend, along with abend information and/or compiler information. Abend information may include the offending source line, program interruption information, or other information related to the event that caused the abend. Compiler information may include diagnostic and cross reference information associated with a program, such as source program 130, and or other information associated with compilation of the program.

In step 220, abend analysis tool 120 determines variable(s) used in the abending source line of source program 130. For example, the abending source line of source program 130 may include a computation that includes one or more variables. In another example, the abending source line of source program 130 may include a command to move the data stored in one variable to another storage location. Abend analysis tool 120 may determine variable(s) used in the abending source line of source program 130 by comparing the abending source line to the source code of source program 130. In addition, abend analysis tool 120 may determine the function or procedure in which the abending line resides. Abend analysis tool 120 may determine the function or procedure in which the abending line resides by accessing the source code of source program 130, or by utilizing received compiler information.

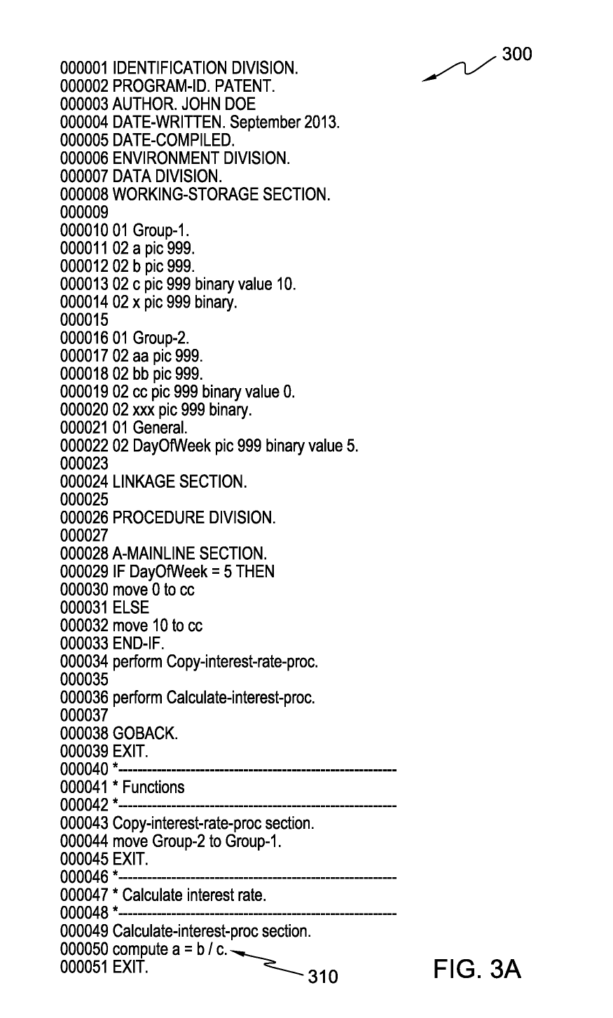

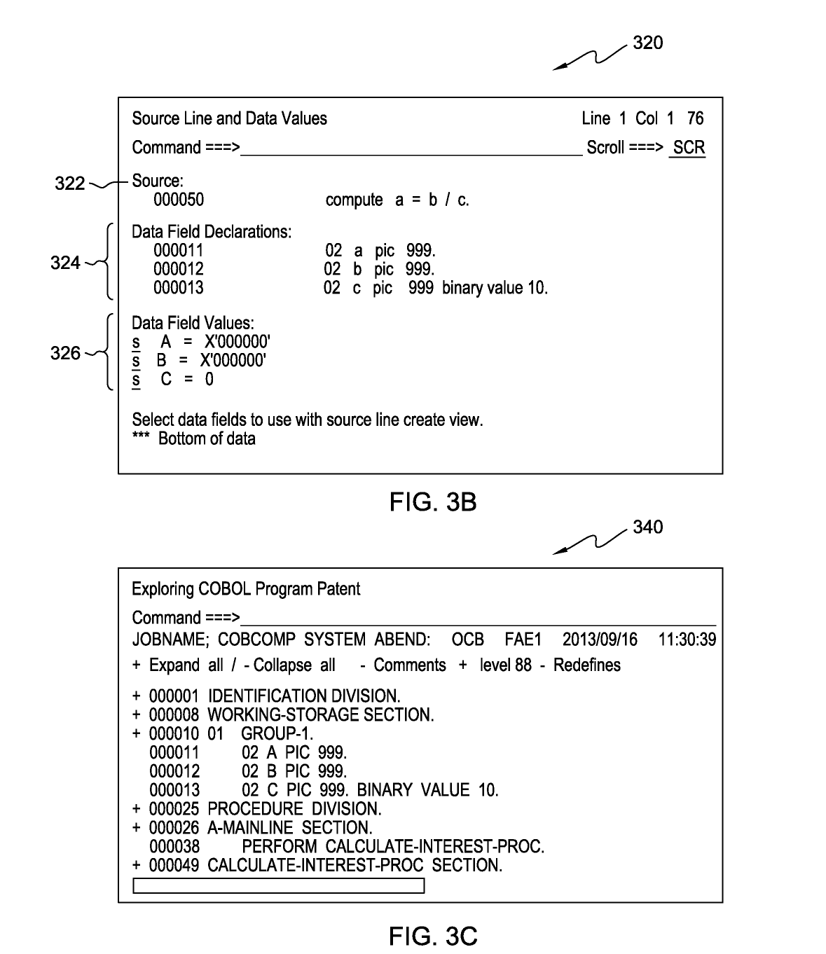

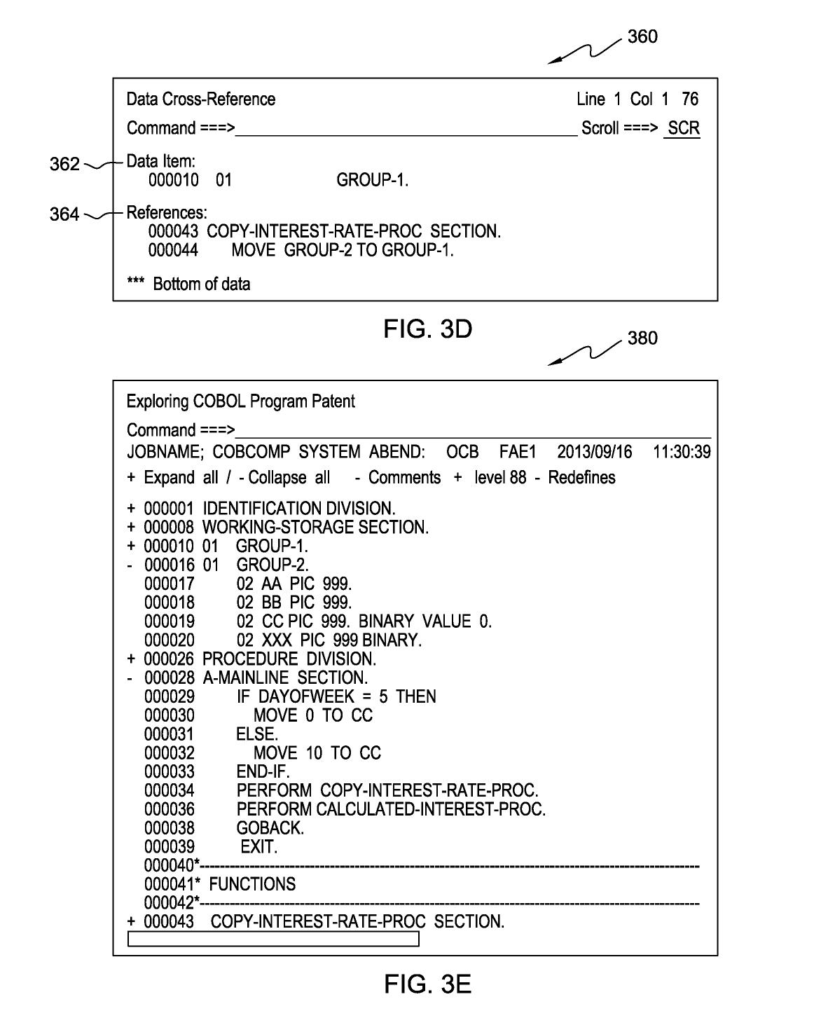

In step 230, abend analysis tool 120 causes a user interface window to be displayed to a user. The user interface window may include the source line, data field declarations for each of the variables used in the source line, and data field values for each of the variables used in the source line (see FIG. 3B). Initially, the source line may be the abending source line. However, a user may also select another source line upon which similar information may be displayed, based on the selected source line. The user interface window displayed by abend analysis tool 120 during step 230 may include one or more selectable elements accessible through UI 100, such as variables or data field values for variables, to be used in generating additional views for analyzing and troubleshooting the cause of the abend to source program 130.

In step 240, abend analysis tool 120 receives the selection of at least one variable. In some embodiments, the selected variable will be a variable presented to the user via the user interface discussed with respect to step 230. A variable may be selected by a user through UI 100 via a selectable element, such as a button or checkbox, or by another means of inputting a user selection. In some embodiments, abend analysis tool 120 may prompt a user for a selection with a pop-up window, modal window, or other means of notification. Abend analysis tool 120 may receive the selection of at least one variable through a user interaction and input with any of the previously described methods of selection.

In step 250, abend analysis tool 120 causes a user interface window to be displayed, such as the user interface window depicted in FIG. 3C, which includes a filtered branch analysis and data cross-reference view of source program 130, based on the variable selection(s) received by abend analysis tool 120. The user interface window presented may include a filtered and reduced, or truncated, version of the source code of source program 130, based on the variable selection(s) received by abend analysis tool 120. For example, the user interface may include declarations of the selected variable(s), modifications to the selected variable(s), functions or procedures that use the selected variable(s), and additional relevant information. In some embodiments, the user interface window may include a version of the source code of source program 130 that has been collapsed, or otherwise truncated, such that only relevant portions of the code, based on the selected variables, are displayed. In some embodiments, collapsed sections of the code may be expandable through the selection of a selectable element via UI 100. For example, various lines of the code may include a plus, to expand and reveal that section of the code (i.e., to bring to view the lines of code that immediately follow the selected section, which were previously hidden from view), or a minus, to collapse that section of the code. In some embodiments, the user interface window generated by abend analysis tool 120 may allow for the selection of data items or source code lines, the selection of which may cause a pop-up window or additional user interface window to appear, as discussed with reference to step 270.

In decision 260, abend analysis tool 120 determines whether an item, from the user interface window generated by step 250, has been selected. Items may include variables, source code lines, functions, procedures, or other items displayed within the user interface generated by step 250. Abend analysis tool 120 may determine that an item has been selected by receiving input from a user through UI 100, such as by double clicking a particular item, or otherwise selecting a particular item. If an item is not selected (decision 260, no branch), abend analysis tool 120 determines if a user interface display, such as the user interface display discussed with regards to step 230, should be re-executed using different selection criteria, such as by selecting a different source line and set of one or more variables.

If an item is selected (decision 260, yes branch), abend analysis tool 120 causes references for the selected item to be displayed (step 270). In some embodiments, if the selected item is a data element, such as a variable, a pop-up window may be generated that shows all references to the selected data element, and occurrences of the data element throughout the source code. In some embodiments, abend analysis tool 120 may determine occurrences of where the data element is used throughout the source code by searching the source code for instances of the data element. If the selected data element is part of a group or structure, an aggregate map may be displayed detailing higher level data items that contain the data element, the data element's offsets into the group and declarations. In some embodiments, if the selected item is a function or procedure, a pop-up window may be generated and displayed that includes a listing of where the function or procedure selected is called throughout the source code of source program 130. In other embodiments, rather than a pop-up window, abend analysis tool 120 may cause a modal window, menu, or other information displaying means to be generated.

In decision 280, abend analysis tool 120 determines whether additional user interface windows, such as the user interface windows previously described, should be generated using different selection criteria received from a user. Selection criteria may include a different source line and set of one or more variables. If abend analysis tool 120 determines that no additional user interface windows shall be generated (decision 280, no branch), the function is complete. In one embodiment, abend analysis tool 120 may determine that no user interface windows should be generated if no additional, or different, selection criteria is received.

If abend analysis tool 120 determines that a user interface window, such as the user interface described with respect to step 230, should be generated using different selection criteria, abend analysis tool 120 may generate the user interface window according to the selection criteria in a manner similar to steps 230-270. Abend analysis tool 120 may determine that at least an additional user interface window should be generated by receiving an additional, or different, set of selection criteria. For example, a user may access a menu allowing for the selection of additional variables to generate an additional filtered branch analysis based on newly selected variables.

FIGS. 3A-3E depict an example use-case scenario of abend analysis tool 120, in accordance with one embodiment of the present invention. In the depicted Figures, source code 300 (see FIG. 3A) of source program 130 has generated an abend during execution of the code. FIGS. 3B-3E depict example user interface windows generated, and caused to be displayed, by abend analysis tool 120, for access by a user via UI 100 on server 20 or another computing device capable of accessing abend analysis tool 120 (not shown).

FIG. 3A depicts source code 300. In embodiments of the present invention, source code, such as source code 300, may be any source code that, when compiled or executed, results in an abend. In some embodiments, source code, such as source code 300, may be the source code, or a portion thereof, for source program 130. In embodiments of the present invention, source code 300 may be analyzed by a user using an abend analysis tool, such as abend analysis tool 120, in accordance with one embodiment of the present invention. In the depicted embodiment, an abend to source program 130 has occurred at source code line 310, and the resulting abend was caused by an attempt to divide by zero. Embodiments of the present invention may be used to assist a user in troubleshooting and determining problems with source code, such as source code 300, by presenting, to the user, a variety of information relevant to the abend. In the depicted embodiment, source code 300 is represented in the COBOL programming language. However, embodiments of the present invention may act upon a variety of programming language source code data.

FIG. 3B depicts user interface window 320, an example user interface window generated by abend analysis tool 120 based on the abend in source code 300 (see FIG. 3A), in accordance with one embodiment of the present invention. User interface window 320 may be a pop-up, modal, or other window or area of display accessible to a user at server 20. User interface window 320 depicts a window generated by abend analysis tool 120 as a result of the abend within source code 300.

User interface window 320 includes the source line, variable declarations, and current values of the variables. In the depicted figure, user interface window 320 includes source section 322, indicating one or more lines of source code 300 that caused the abend. In the depicted figure, source code line “000050,” labeled as source code line 310 in FIG. 3A, was the source code line of source code 300 that caused the abend, due to the attempt to divide by zero, as previously discussed. In some embodiments of the present invention, user interface window 320 may further include information about the abend, such as an error code or description of possible reasons for the abend. In the depicted figure, user interface window 320 also includes variable declaration section 324. Variable declaration section 324 may include the source code line(s) for variable declarations of variables used by any source code lines located within source section 322. In the depicted figure, variables “a,” “b,” and “c” are variables used within source code line “00050.” As such, user interface window 320 includes the source code lines that declared those variables. Current value section 326 includes the value of each variable at the time of the abend, for each variable used by the source code line (i.e., variables “a,” “b,” and “c”).

In embodiments of the present invention, abend analysis tool 120 allows for the selection of one or more variables in order to generate additional user interface windows which may include additional information relating to a cause of the abend. In the depicted figure, current value section 326 allows for a user to indicate the selection of one or more of the variables listed within section 326. In the depicted figure, the user has chosen to select each of variables “a,” “b,” and “c,” as illustrated by an “s” located next to each variable.

FIG. 3C depicts user interface window 340, in accordance with an embodiment of the present invention. Upon selection of one or more variables listed within section 326, abend analysis tool 120 may generate, and cause to be displayed, user interface window 340. User interface window 340 may be a pop-up, modal, or other window or area of display accessible to a user at server 20, via UI 100. In accordance with embodiments of the present invention, user interface window 340 depicts a filtered branch analysis, based upon the selection criteria. User interface window 340 includes a collapsed version of source code 300, such that sections of source code 300 are hidden from view. Abend analysis tool 120 may collapse portions of source code 300 based upon selected variables received. In the depicted embodiment, collapsed sections of source code 300 may be expanded, or revealed, by selecting a “+” next to a source code line of source code 300. In some embodiments, a user may collapse an expanded section of source code 300 by selecting a “−” next to a source code line of source code 300 (see FIG. 3E). Sections of source code 300 may be expanded or collapsed in a user interface window, such as user interface window 340, according to any known means for expanding or collapsing information within a computing environment. Embodiments of abend analysis tool 120 may allow for the selection of an item or source code line within user interface window 340, and based on such a selection, abend analysis tool 120 may generate a user interface window with additional information.

FIG. 3D depicts user interface window 360, in accordance with one embodiment of the present invention. As depicted, user interface window 360 includes selected item 362 and reference section 364. Selected item 362 is the item that has been selected from within another user interface window, such as user interface window 340 of FIG. 3C. In the depicted embodiment, selected item 362 is “GROUP-1.” Reference section 364 includes each source code line in which selected item 362 is referenced within source code 300. Reference section 364 may also include additional source code lines, such as headers or function names associated with source code lines referencing selected item 362. In some embodiments, user interface window 360 may additionally include aggregate map information, such as when selected item 362 is located within a group or structure. If, rather than a variable, a user selects a procedure or function as selected item 362, all branches to the procedure or function may be shown within reference section 364. If a user selects a heading identifying where characteristics of data are defined, such as a data division section heading, as selected item 362, a varied user interface may be displayed that includes all variables and values associated with the variables in that section.

FIG. 3E depicts user interface window 380, in accordance with an embodiment of the present invention. User interface window 380 is a re-execution of user interface window 340, as depicted in FIG. 3C, according to different selection criteria. User interface window 380 includes sections of source code 300 that have been expanded. Expanded sections of user interface window 380 are indicated by a “-.”

FIG. 4 depicts a block diagram of components of server 20 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server 20 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

IDE 110, abend analysis tool 120, and source program 130 are stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. IDE 110, abend analysis tool 120, and source program 130 may be downloaded to persistent storage 408 through communications unit 410.

I/O interface(s) 412 allows for input and output of data with other devices that may be connected to server computer 20. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., IDE 110, abend analysis tool 120, and source program 130, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1-7. (canceled)

8. A computer program product for providing information to resolve an abnormal termination of software, the computer program product comprising:
one or more computer readable storage media and program instructions stored on the one or more computer readable storage media, the program instructions comprising:
program instructions to receive a notification of an abnormal termination of software at a source line within a source code;
program instructions to determine at least one variable from the source line;
program instructions to cause information about the at least one variable to be displayed, wherein information about a variable comprises a variable declaration source line and a value of the variable;
program instructions to receive a first selection of at least one variable from the source line; and
program instructions to cause a first branch analysis to be displayed, wherein the first branch analysis comprises a truncated version of the source code based on the received first selection.

9. The computer program product of claim 8, further comprising:
program instructions, stored on the one or more computer readable storage media, to receive compiler information, wherein the compiler information includes diagnostic information and cross reference information.

10. The computer program product of claim 8, wherein the first branch analysis includes at least one selectable element, wherein selection of the selectable element causes the first branch analysis to expand and reveal at least an additional portion of the source code.

11. The computer program product of claim 8, further comprising:
program instructions, stored on the one or more computer readable storage media, to receive a selection of an item from the first branch analysis; and
program instructions, stored on the one or more computer readable storage media, to cause information to be displayed about the item.

12. The computer program product of claim 11, wherein the selected item is a variable; and
wherein the information to be displayed about the item comprises at least a source code line where the variable is used.

13. The computer program product of claim 11, wherein the selected item is a function; and
wherein the information to be displayed about the item comprises at least a source code line where the function is called.

14. The computer program product of claim 8, further comprising:
program instructions, stored on the one or more computer readable storage media, to receive a second selection of at least one variable from the source code, wherein the second selection is different than the first selection; and
program instructions, stored on the one or more computer readable storage media, to cause a second branch analysis to be displayed, wherein the second branch analysis comprises a truncated version of the source code based on the received second selection.

15. A computer system for providing information to resolve an abnormal termination of software, the computer system comprising:
one or more computer processors, one or more computer readable storage media, and program instructions stored on the computer readable storage media for execution by at least one of the one or more processors, the program instructions comprising:
program instructions to receive a notification of an abnormal termination of software at a source line within a source code;
program instructions to determine at least one variable from the source line;
program instructions to cause information about the at least one variable to be displayed, wherein information about a variable comprises a variable declaration source line and a value of the variable;
program instructions to receive a first selection of at least one variable from the source line; and
program instructions to cause a first branch analysis to be displayed, wherein the first branch analysis comprises a truncated version of the source code based on the received first selection.

16. The computer system of claim 15, further comprising:
program instructions, stored on the computer readable storage media for execution by at least one of the one or more processors, to receive compiler information, wherein the compiler information includes diagnostic information and cross reference information.

17. The computer system of claim 15, wherein the first branch analysis includes at least one selectable element, wherein selection of the selectable element causes the first branch analysis to expand and reveal at least an additional portion of the source code.

18. The computer system of claim 15, further comprising:
program instructions, stored on the computer readable storage media for execution by at least one of the one or more processors, to receive a selection of an item from the first branch analysis; and
program instructions, stored on the computer readable storage media for execution by at least one of the one or more processors, to cause information to be displayed about the item.

19. The computer system of claim 18, wherein the selected item is a variable; and
wherein the information to be displayed about the item comprises at least a source code line where the variable is used.

20. The computer system of claim 18, wherein the selected item is a function; and
wherein the information to be displayed about the item comprises at least a source code line where the function is called.
